(19) United States
(12) Patent Application Publication
(10) Pub. No.: US 2012/0118649 A1
(43) Pub. Date: May 17, 2012

(54) LOAD CELL

(75) Inventors: Andrew C. Clark, Greenville, SC (US); David Topham, Charleston, SC (US)

(73) Assignee: SENSORTECH CORPORATION, Greenville, SC (US)

(21) Appl. No.: 13/254,976

(22) PCT Filed: Mar. 8, 2010
(86) PCT No.: PCT/US10/26575

§ 371 Date: Nov. 16, 2011

Related U.S. Application Data
(60) Provisional application No. 61/157,946, filed on Mar. 6, 2009.

(51) Int. Cl. G01G 3/14

(52) U.S. Cl. 177/211

(57) ABSTRACT

A load cell is presented that has a load cell housing defining an interior cavity. The load cell housing also defines an bore in a first exterior face. In another aspect, the load cell has a load member positioned within the interior cavity, where a load knob protrudes out of the bore and above the first exterior face. In one aspect, the load cell also has a first electrode and a second electrode positioned within the interior cavity. In another aspect, a conductive polymer element is positioned therebetween the first and second electrodes.

### CROSS-REFERENCE TO RELATED APPLICATIONS

This application claims the benefit of U.S. Provisional Application No. 61/157,946, filed on Mar. 6, 2009, which application is herein incorporated by reference in its entirety.

### BACKGROUND OF THE INVENTION

1. Field of the Invention

This invention relates to load cells, and more particularly to load cells for accurately measuring both dynamic and static loads and methods for manufacturing such load cells.

2. Description of the Related Art

Load cells are used in various situations where it is necessary to measure a force exerted on an object or a surface. A load cell is conventionally a transducer which converts force into a measurable electrical output. There are many varieties of load cells, of which strain gage based load cells are the most commonly used type.

Mechanical scales can weigh most objects fairly accurately and reliably if they are properly calibrated and maintained. The method of operation can involve either the use of a weight balancing mechanism or the detection of the force developed by mechanical levers. Other types of force sensors included hydraulic and pneumatic designs. In 1843, English physicist Sir Charles Wheatstone devised a bridge circuit that could measure electrical resistances. The Wheatstone bridge circuit is used for measuring the resistance changes that occur in strain gages. Strain gage load cells are currently the predominate load cell in the weighing industry. Pneumatic load cells are sometimes used where intrinsic safety and hygiene are desired, and hydraulic load cells are considered in remote locations, as they do not require a power supply.

Hydraulic load cells are force-balance devices, measuring weight as a change in pressure of the internal filling fluid. In a rolling diaphragm type hydraulic load cell, a load or force acting on a loading head is transferred to a piston that in turn compresses a filling fluid confined within an elastomeric diaphragm chamber. As force increases, the pressure of the hydraulic fluid rises. This pressure can be locally indicated or transmitted for remote indication or control. Output is linear and relatively unaffected by the amount of the filling fluid or by its temperature. Typical hydraulic load cell applications include tank, bin, and hopper weighing.

Pneumatic load cells also operate on the force-balance principle. These devices use multiple dampener chambers to provide higher accuracy than can a hydraulic device. Pneumatic load cells are often used to measure relatively small weights in industries where cleanliness and safety are of prime concern. The advantages of this type of load cell include their being inherently explosion proof and insensitive to temperature variations. Additionally, they contain no fluids that might contaminate the process if the diaphragm ruptures. Disadvantages include relatively slow speed of response and the need for clean, dry, regulated air or nitrogen.

Strain-gage load cells convert the load acting on them into electrical signals. The gauges themselves are bonded onto a beam or structural member that deforms when weight is applied. In most cases, four strain gages are used to obtain maximum sensitivity and temperature compensation. Two of the gauges are usually in tension, and two in compression, and are wired with compensation adjustments. When weight is applied, the strain changes the electrical resistance of the gauges in proportion to the load.

Conductive polymer contact sensors can be used to gather information concerning contact or near-contact between two surfaces in various applications. For instance, refer to U.S. Patent Application Publication No. 2006/0184067, which is incorporated by reference in its entirety. What are needed in the art are load cells that can provide more accurate and/or dynamic load information in an inexpensive manner using a conductive polymer sensor.

### SUMMARY OF THE INVENTION

Presented herein are aspects of a load cell. In one aspect, the load cell comprises a load cell housing defining an interior cavity. The load cell housing also defines an opening in a first exterior face. In another aspect, the load cell comprises a load member positioned within the interior cavity, where a load knob protrudes out of the opening and above the first exterior face. The load knob, for example, can be connected directly to the load member, or it can be integral with the load member.

In one aspect, the load cell further comprises a first electrode and a second electrode positioned within the interior cavity. In another aspect, a conductive polymer sensor substantially separates the first and second electrodes.

In operation, in one aspect, a power source can be connected to the load cell via the first and second electrodes. The conductive polymer sensor between the two electrodes completes an electrical circuit. When a force is applied to the load knob, the load is transferred to the first and second electrodes and conductive polymer sensor, compressing the conductive polymer sensor. As the force increases, the current flow through the conductive polymer sensor from the first electrode to the second electrode increases. This current flow can be measured by conventional means and converted to engineering units to calculate the load cell output.

### BRIEF DESCRIPTION OF THE FIGURES

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 is a partially transparent perspective view of a load cell as presented herein;

FIG. 2 is a partially transparent exploded perspective view of the load cell of FIG. 1;

FIG. 3 is an exploded side elevational view of the load cell of FIG. 1;

FIG. 4 is a partially transparent top plan view of the load cell of FIG. 1;

FIGS. 5A and 5B are SEM images of carbon black powder including images of primary particles, aggregates, and agglomerations;

FIGS. 6A and 6B are SEM images of a single UHMWPE granule;

FIGS. 7A and 7B are SEM images of a single UHMWPE granule following formation of a powder mixture including 8 wt % carbon black with UHMWPE;

FIG. 8 is a hysteresis graph, illustrating the correlation between force and output for forces up to 1000 lbs in an exemplary load cell;

FIG. 9 is a hysteresis graph, illustrating the correlation between force and output for forces up to 500 lbs in an exemplary load cell;

FIG. 10 is an output graph, illustrating the correlation to the output of an exemplary load cell and the change in resistance of a conductive polymer sensor as the mechanical load applied to the load cell is increased;

FIG. 11 is a partially exploded perspective view of a load cell, as presented herein, showing a substantially convex bottom portion of a load member and a substantially convex top portion of a first electrode;

FIG. 12 is a schematic illustration of simplified electrical circuit for the load cell;

FIG. 13 is a schematic illustration of the conditioning module of the load cell;

FIG. 14 illustrates a simplified, non-limiting block diagram showing select components of an exemplary operating environment for performing the disclosed methods; and

FIGS. 15 and 16 illustrates an exemplary schematic for timing the process of data through the A/D converter.

### DETAILED DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “electrode” includes aspects having two or more electrodes unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

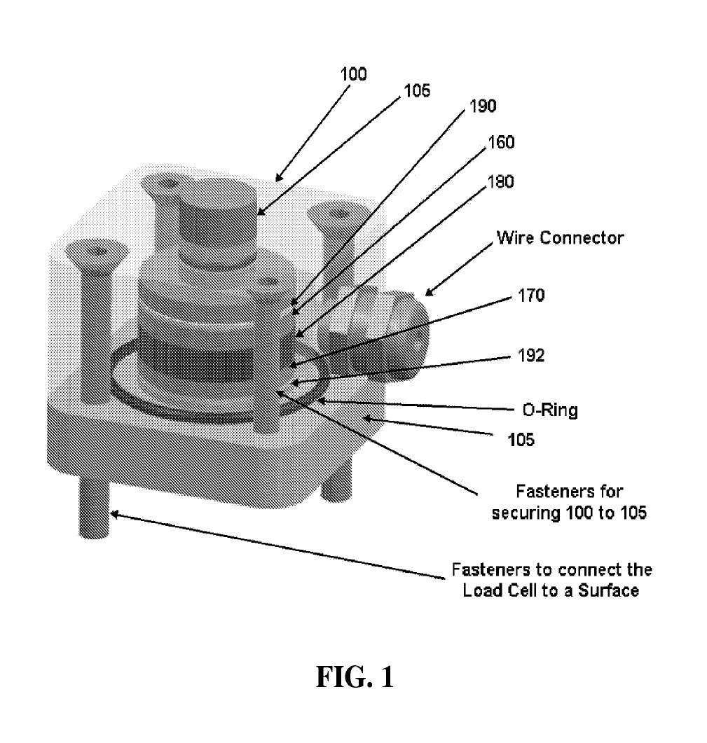

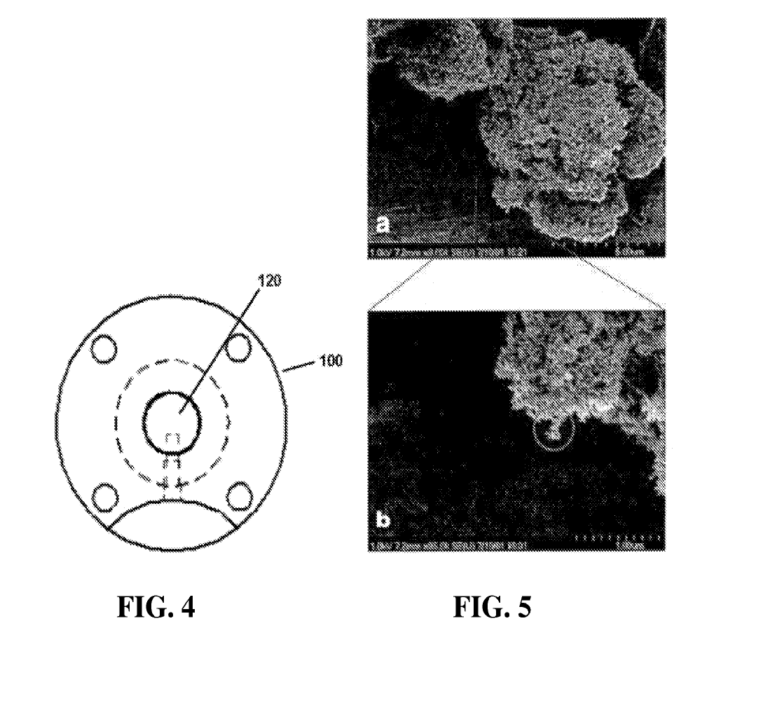

Presented herein are aspects of a load cell 10. In one aspect, and with reference to FIGS. 1-4, the load cell 10 comprises a load knob 150. A distal end of the load knob 150, for example, can be connected to a load member 140, which can optionally be formed integral with the load member. Optionally, the load cell 10 can comprise a load cell housing 100. In one aspect, the load cell housing 100 can define an interior cavity 110. In this aspect, the load cell housing 100 can also define a bore 120 in a first exterior face 130 of the load cell housing. In another aspect, the load member 140 can be positioned within the interior cavity 110 of the load cell housing 100. In this aspect, a proximal end of the load knob 150 can protrude out of the bore 120 and above the first exterior face 130 of the load cell housing 100. As shown, in one aspect, it is contemplated that the load knob is configured to cooperate with the bore 120 of the load cell housing such that the load knob can move axially relative to the first exterior face 130 of the load cell housing 100. For example, a load impacting or placed thereon the load knob can cause the load knob to translate axially and impart a like compressive force, via the distal end of the load knob, on portions of the load cell that underlie and are otherwise in operative contact with the load knob.

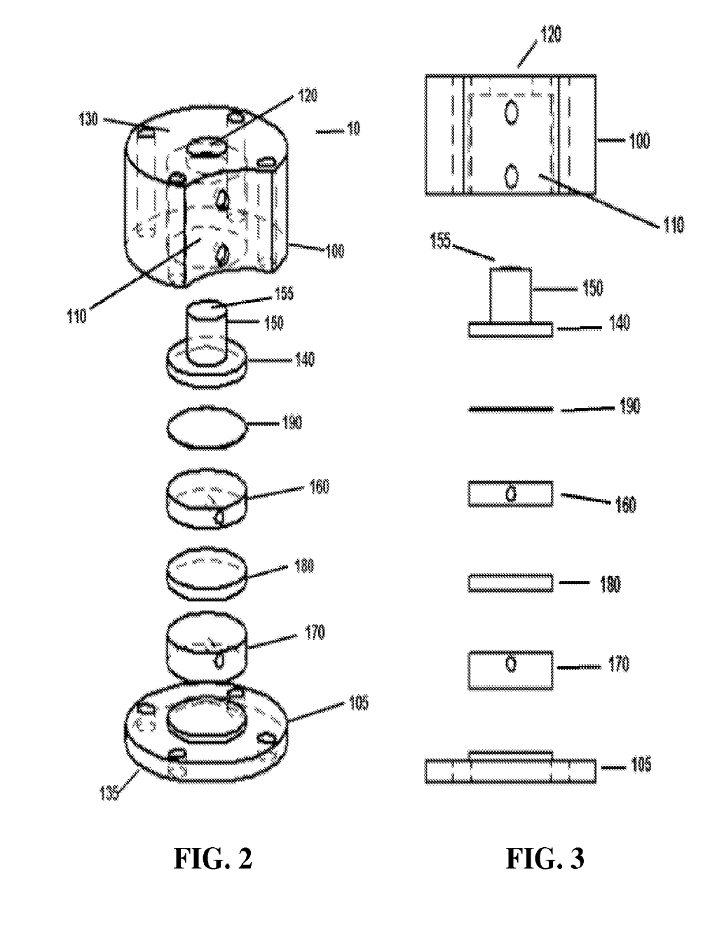

In one aspect, the load cell 10 further comprises a first electrode 160 and a second electrode 170 positioned within the interior cavity 110 of the load cell housing 100. In another aspect, a conductive polymer element 180 substantially separates the first and second electrodes 160, 170. In this aspect, the first electrode 160 can substantially underlie the load member, and the second electrode 170 can substantially overlie a second exterior face 135 of the load cell housing 110, which opposes the first exterior face 130, as illustrated in FIG. 2. In one aspect, and as described in more detail below, the conductive polymer element is substantially inflexible. Optionally, the polymer element is substantially planar and is positioned in substantially uniform contact with the respective faces of the first and second electrodes. In one exemplary aspect, the conductive polymer element can have a disk shape, however, any other geometric shape will suffice.

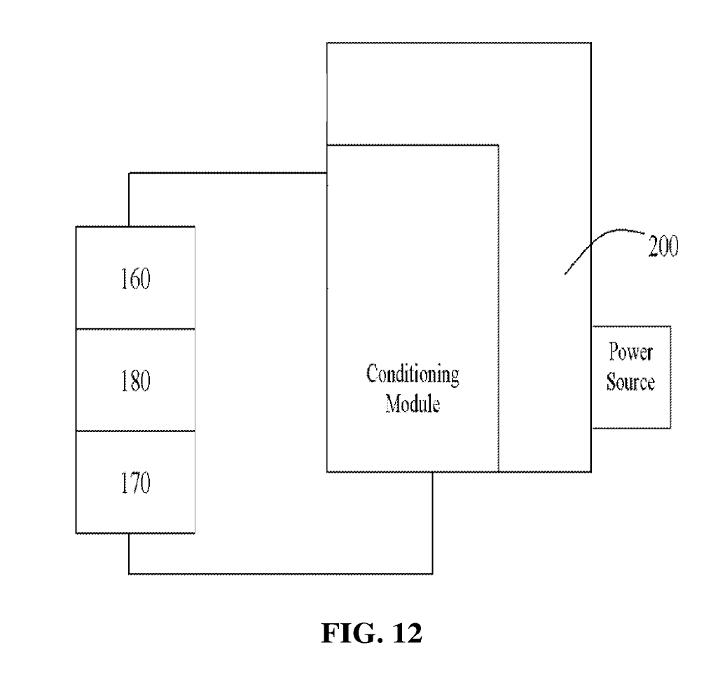

In operation, in one aspect, an excitation voltage is operably applied to the load cell 10 via the first and second electrodes 160, 170. The conductive polymer element 180 between the two electrodes 160, 170 completes an electrical circuit. An exemplary schematic of the electrical circuit is shown in FIG. 12.

In operation, when a compressive force is applied to the load knob 150, the load is transferred to the first and second electrodes 160, 170 and conductive polymer element 180, which effects a compression of the conductive polymer element. As the compressive force increases, the current flow through the conductive polymer element 180 from the first electrode 160 to the second electrode 170 increases because the resistance in the conductive polymer element 180 decreases. Alternatively, when a tensile force is applied to the load knob 150, the resistance in the conductive polymer element 180 increases, thus reducing the current flow. In this aspect, the load cell can be pre-loaded and calibrated to measure both compressive and tensile forces. This current flow can be measured by conventional means and converted to engineering units to calculate a load cell output.

In another aspect, the measured load cell output can be communicated to a conditioning module for electrical processing. It is contemplated that the load cell output can be substantially non-linear. In one aspect, the conditioning module can comprise a microcontroller configured to convert the measured load cell output into a substantially linear output (the converted load cell output) that can be processed by conventional data collection terminals. In this aspect, it is contemplated that the load cell output can range from about 4 mA to about 20 mA. It is further contemplated that the converted load cell output can be displayed on a light-emitting diode (LED) readout or other conventional display means.

In an additional aspect, the conditioning module can comprise a shunt resistor in electrical communication with the first and second electrodes 160, 170 and the conductive polymer element 180 of the load cell 10. In this aspect, the shunt resistor can have a resistance ranging from about 2 Ohms to about 10,000 Ohms, more preferably ranging from about 10 Ohms to about 1,000 Ohms, and most preferably ranging from about 100 Ohms to about 300 Ohms. In a further aspect, the conditioning module can comprise an analog/digital converter (A/D converter) for measuring the voltage drop across the shunt resistor. In this aspect, the A/D converter can be in communication with the microcontroller to digitally filter and display the converted load cell output. Optionally, the converted load cell output can be transmitted through a digital/analog (D/A converter) to output a substantially linear signal that can be read by conventional industrial data collection terminals, thereby permitting electrical interaction with other conventional industrial equipment. For example, it is contemplated that the load cell can be used in a feedback loop to control the operation of a conventional industrial device based on the load cell output.

In still a further aspect, the conditioning module can be powered by a power source. In this aspect, the power source of the conditioning module can be a low voltage power source. It is contemplated that the power source can provide a voltage of 24 Volts (DC) or another common voltage available in conventional industrial settings. It is further contemplated that the load cell output, prior to conversion, can have a substantially greater amplitude than the outputs of conventional load sensors, thereby reducing the susceptibility of the load cell output to noise and other sources of interference.

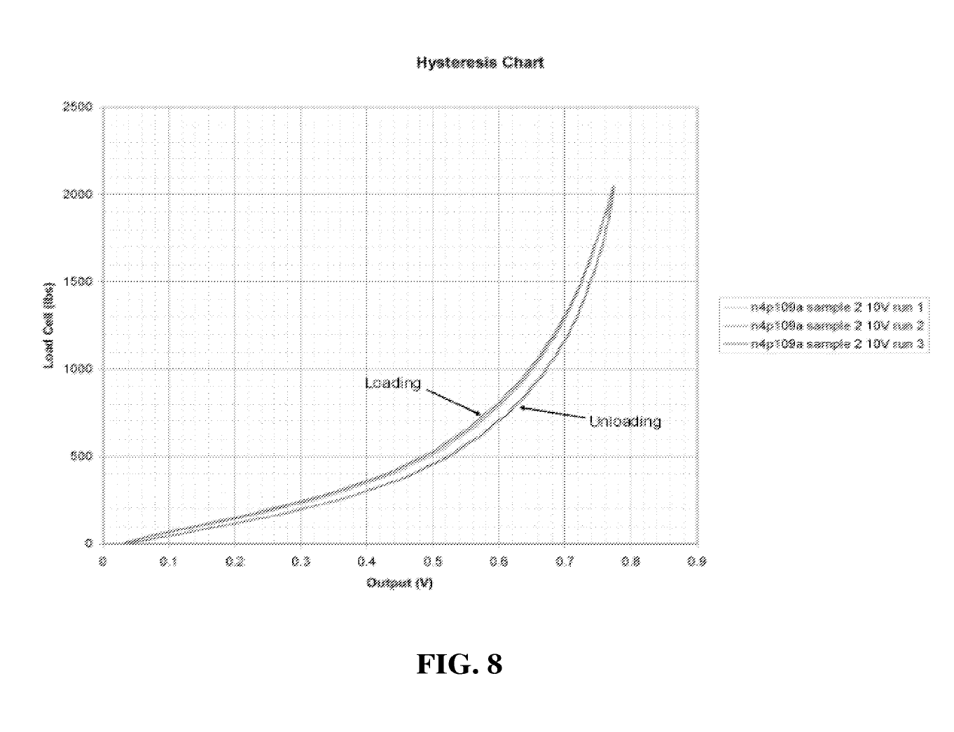

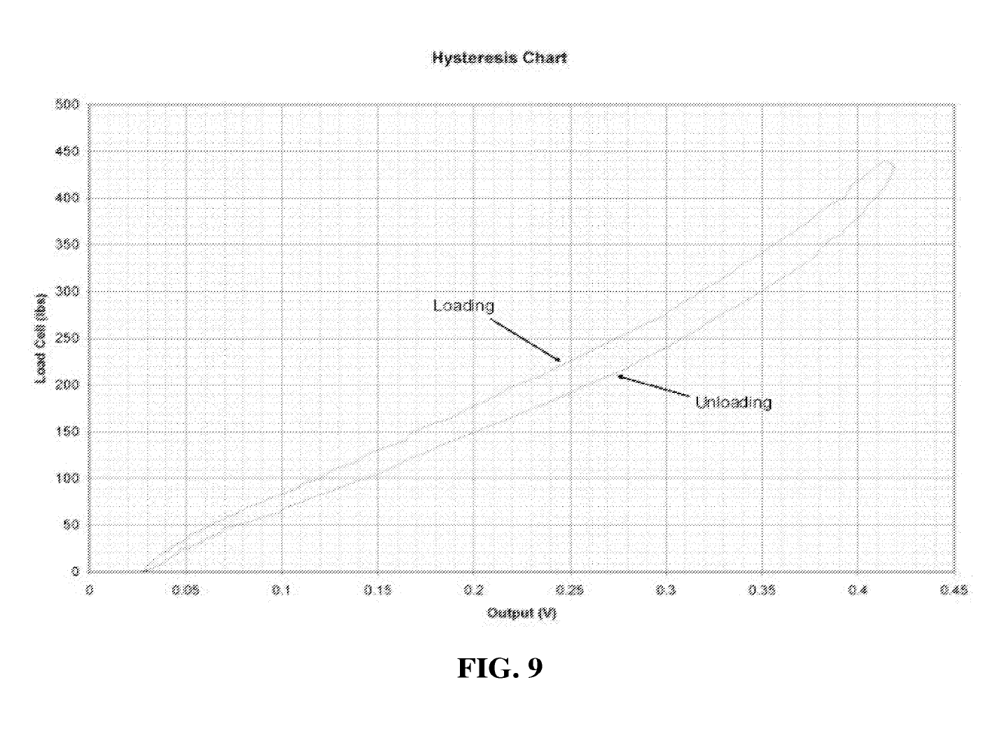

In one exemplary aspect, as shown in FIGS. 8-9, it can be appreciated that, upon application of a load, the potential measured across the conductive polymer element increases. As shown in FIGS. 8-9, at least initially, the output increases substantially linearly. As the load increases, the measured output increases at a greater rate, as illustrated on the graph of FIGS. 8-9, where the slope of the line representing output increases with greater load. As one can appreciate, these load graphs can be used to calibrate the load cell.

Additionally, as illustrated in FIGS. 8-9, the characteristics of the load versus output graph indicate that, after loading, and upon unloading, the load cell can experience hysteresis. Thus, the signal processing component necessary for correlating the voltage or current to the load can be implemented using software capable of correlating the load during loading to the output according to the loading portion of the graph, and correlate the load during unloading to the unloading portion of the graph. In another aspect, the software can calculate the load during static loading (i.e. at a point at which the load is constant) by estimating a point between the loading portion of the graph and the unloading portion of the graph.

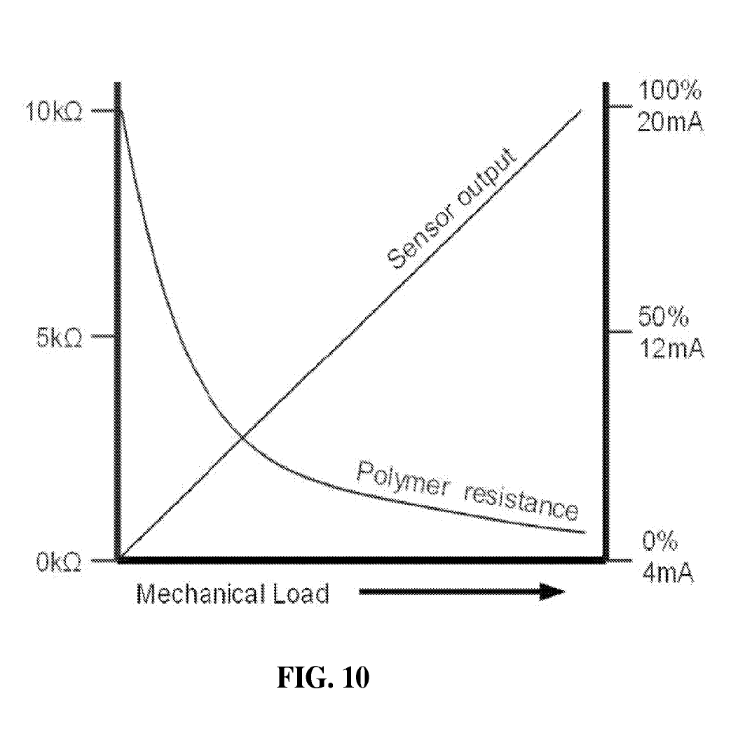

In another aspect, as depicted in FIG. 10, it is contemplated that the conductive polymer element of the load cell can have greater sensitivity at smaller loads than at larger loads. This greater sensitivity at smaller loads translates into a sharp drop in the resistance of the conductive polymer element as the load increases. Accordingly, it is contemplated that the load cells described herein can produce outputs at higher resolutions than conventional strain gauge load cells. In particular, it is contemplated, in a comparison between a load cell described herein and a conventional strain gauge load cell, where both load cells have equal maximum loading capabilities (full scales), the load cell described herein can have superior accuracy from about 0.001% full scale to about 10% full scale of the load cells. Thus, a 1,000 pound load cell as described herein can have greater accuracy than a 1,000 pound conventional strain gauge load cell at loads ranging from about 0.01 pounds to about 100 pounds.

In a further aspect, the load cell can be configured to measure dynamic loads in addition to static loads. In this aspect, the load cell can have a response time indicative of the time between transfer of a load to the load cell and generation of the load cell output. It is contemplated that the response time of the load cell can range from about 1 microsecond to about 10 microseconds. However, it is contemplated that the load cell can have other response times as desired depending on the end use of the load cell. The response time of the load cell can closely approximate the response times of conventional piezo-electric load cells, which are regularly used within the art to measure dynamic loads. Thus, the load cells described herein can be used to perform measurements of dynamic loads. However, unlike conventional piezo-electric load cells, the load cells described herein can also accurately measure static loads, eliminating the need for a separate load cell, such as a conventional strain gauge. Therefore, the load cells described herein can be used to accurately conduct measurements of both dynamic and static loads.

In one aspect, at least a portion of the exterior surface 155 of the proximal end of the load knob can comprise an arcuate surface. In another aspect, the exterior surface 155 of the load knob is semi-spherical. In this aspect, forces directed onto the exterior surface 155 of the load knob 150 are substantially axially transferred to the first electrode and tangential forces are minimized.

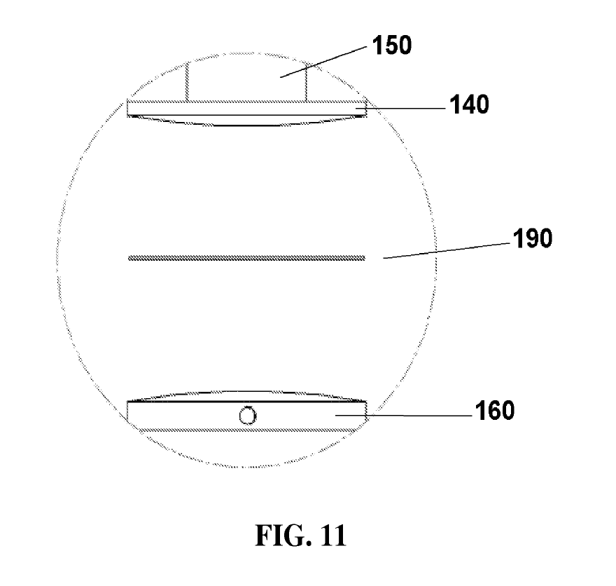

In another exemplary aspect, at least a portion of the distal end of the bottom portion of the load member can be substantially convex, as shown in FIG. 11. In this aspect, a top portion of the first electrode may also be substantially convex. Thus, a load applied to the load member that is not axial to the first electrode would be translated substantially axially. Alternatively, at least a portion of the exterior surface of the load knob may be connected to a portion of the load member pivotally, such that, as a non-axial force is applied to the load knob, at least a portion of the applied forces are directed axially to the first conductor and, thus, can be calibrated.

In another aspect, an first insulator 190 can be positioned between the load member 140 and the first electrode 160. In this aspect, a second insulator 192 can be positioned between the second electrode 170 and the lower housing 105. The respective first and second insulators 190, 192 can comprise, for example and not meant to be limiting, polytetraflouroethylene (“PTFE”). In one aspect, the load cell housing can comprise a low friction material, such as for example, ultra high molecular weight polyethylene (“UHMWPE”).

In another aspect, the load cell can comprise a thermistor that is configured to change it's resistance in response to temperature. In one aspect, it is contemplated that the thermistor can be positioned within the load cell housing. In operation, the thermistor reads the temperature inside the load cell housing and compensates the output based on the sensed temperature. When the temperature increases, the output increases, so the microcontroller compensates for that artificial increase by artificially decreasing the output such that at a constant force, the load cell will read the same force regardless of what the load cell's temperature is. Generally, the controller or computer can use a gain value to multiply all the lookup table values depending on the temperature measured at any given moment.

In one aspect, and with reference to FIGS. 1-4, the load cell housing 100 comprises a substantially cylindrical shape, while the internal components within the interior cavity (i.e. the electrodes, the conductive polymer element, and the insulator) can comprise a complementary disc shape. In this aspect, the tolerances between the internal components and the load cell housing 100 are substantially tight in order to allow the parts to transfer force with very little motion. In another aspect, the internal components can have an outside diameter ranging from about 0.500″ to about 1.500″. For example, and without limitation, the internal components can have an outside diameter of about 1.000″. In an additional aspect, the load cell housing 100 can have an inner diameter ranging from about 0.500″ to about 1.500″. For example, and without limitation, the load cell housing 100 can have an inner diameter of about 1.010″. In a further aspect, the internal components can have a thickness ranging from between about 0.020″ to about 0.500″, more preferably from between about 0.050″ to about 0.350″.

In an additional aspect, the conductive polymer element can be configured to withstand a maximum pressure before a pressure overload occurs, at which point the conductive polymer element loses calibration and plastically deforms. In this aspect, it is contemplated that the maximum pressure that the conductive polymer element can withstand can be about 12,000 pounds per square inch. In a further aspect, it is contemplated that the load cells described herein can be configured to withstand overloads ranging from between about 2 times full scale to about 15 times full scale, more preferably ranging from between about 4 times full scale to about 12 times full scale. It is further contemplated that the diameter—and cross-sectional area—of the internal components within the interior cavity of the load cell housing 100 can be increased to provide additional overload protection. For example, and without limitation, a load cell as described herein having internal components with a diameter of 1″ and a full scale of 1,000 pounds can withstand a load of approximately 10,000 pounds. However, if the diameter of the internal components was increased, then the load cell could withstand an even greater load.

In a further aspect, the load cells described herein can have a zero balance indicative of the load cell output when no load is applied. In this aspect, and with reference to FIGS. 1-4, it is contemplated that because the conductive polymer element 180 has only minimal contact with other internal components of the load cell 10 when no load is applied, there is substantially no current flowing through the sensor. Consequently, when no load is applied to load cell 10, there will be substantially no load cell output. In contrast, strain gauge sensors and other conventional load cells can have zero balances ranging from about 1% to about 5% of full scale.

In yet another aspect, the second exterior face 135 of the load cell housing is attached to the load cell housing a plurality of fasteners, such as screws. In one aspect, a lower housing 105 comprises the second exterior face. In this aspect, a portion of the lower housing 105 protrudes into the interior cavity of the load cell housing 100. In this aspect, tightening of the fasteners secures the lower housing onto the load cell housing and provides a compressive pre-load for the internal components. In this aspect, the load knob can be compressed to measure compressive force, or the load knob may be pulled, measuring tensile force.

In one aspect, the conductive polymer element 180 can include an electrically conductive pressure sensitive composite material. In general, any polymeric material that can be combined with an electrically conductive filler to form a pressure sensitive conductive polymeric composite material that can then be formed into an essentially inflexible shape can be utilized for the conductive polymer element. For instance, various polyolefins, polyurethanes, polyester resins, epoxy resins, and the like can be used. In certain aspects, the composite material can include engineering and/or high performance polymeric materials. In one aspect, the composite material can include polyphenolyne sulfide (“PPS”). PPS comprises a high modulus of elasticity, which is beneficial for maintaining dimensional stability under load. In another aspect, the composite material can include UHMWPE. UHMWPE is generally classified as an engineering polymer, and possesses a unique combination of physical and mechanical properties that allows it to perform extremely well in rigorous wear conditions. In fact, it has the highest known impact strength of any thermoplastic presently made, and is highly resistant to abrasion, with a very low coefficient of friction. As can be appreciated, other thermoplastics with substantially similar characteristics can be used.

According to one aspect, a pressure sensitive conductive composite material can be formed by combining a desired amount of conductive filler with a polymeric material. In one aspect, the desired amount of conductive filler can range from about 0.2% to about 20% by weight of the composite material, more preferably from about 0.5% to about 10% by weight of the composite material, and most preferably from about 1% to about 3% by weight of the composite material. Of course, in other aspects, the composite material can include a higher weight percentage of the conductive filler material.

In general, the polymeric material and the conductive filler can be combined in any suitable fashion, which can generally be determined at least in part according to the characteristics of the polymeric material. For example, and depending upon the polymers involved, the materials can be combined by mixing at a temperature above the melting temperature of the polymer (conventional melt-mixing) and the filler materials can be added to the molten polymer, for instance, in a conventional screw extruder, paddle blender, ribbon blender, or any other conventional melt-mixing device. The materials can also be combined by mixing the materials in an appropriate solvent for the polymer (conventional solution-mixing or solvent-mixing) such that the polymer is in the aqueous state and the fillers can be added to the solution, optionally utilizing an appropriate surfactant if desired, following which the solvent can be allowed or encouraged to evaporate, resulting in the solid conductive composite material. In another aspect, the materials can be mixed below the melting point of the polymer and in dry form, for instance, in a conventional vortex mixer, a paddle blender, a ribbon blender, or the like, such that the dry materials are mixed together before further processing.

It is contemplated that, when mixing the components of the composite material, the mixing can be carried out under any suitable conditions. For instance, in one aspect, the components of the composite material can be mixed at ambient conditions. In other aspects, however, mixing conditions can be other than ambient, for example and without limitation, so as to maintain the materials to be mixed in the desired physical state and/or to improve the mixing process.

When dry mixing the materials to be utilized in the composite, the exact particulate dimensions of the materials are not generally critical to the invention. However, in certain aspects, the relative particulate size of the materials to be combined in the mixture can be important. In particular, the relative particulate size of the materials to be combined can be important in those aspects wherein a relatively low amount of conductive filler is desired and in those aspects wherein the polymer granules do not completely fluidize during processing. For instance, the relative particle size can be important in certain aspects wherein engineering or high-performance polymers are utilized, and in particular, in those aspects utilizing extremely high melt viscosity polymers such as UHMWPE, which can be converted via non-fluidizing conversion processes, such as compression molding or RAM extrusion processes.

In such aspects, the particle size of the filler can beneficially be considerably smaller than the particle size of the polymer. According to this aspect, and while not wishing to be bound by any particular theory, it is believed that due to the small size of the conductive filler particles relative to the larger polymer particles, the conductive filler is able to completely coat the polymer during mixing and, upon conversion of the composite polymeric powder in a non-fluidizing conversion process to the final solid form, the inter-particle distance of the conductive filler particles can remain above the percolation threshold such that the composite material can exhibit the desired electrical conductivity. According to this aspect, when forming the composite mixture, the granule or aggregate size of the conductive filler to be mixed with the polymer can be at least about one order of magnitude smaller than the granule size of the polymer. In some aspects, the granule or aggregate size of the conductive filler can be at least about five orders of magnitude smaller than the granule size of the polymer.

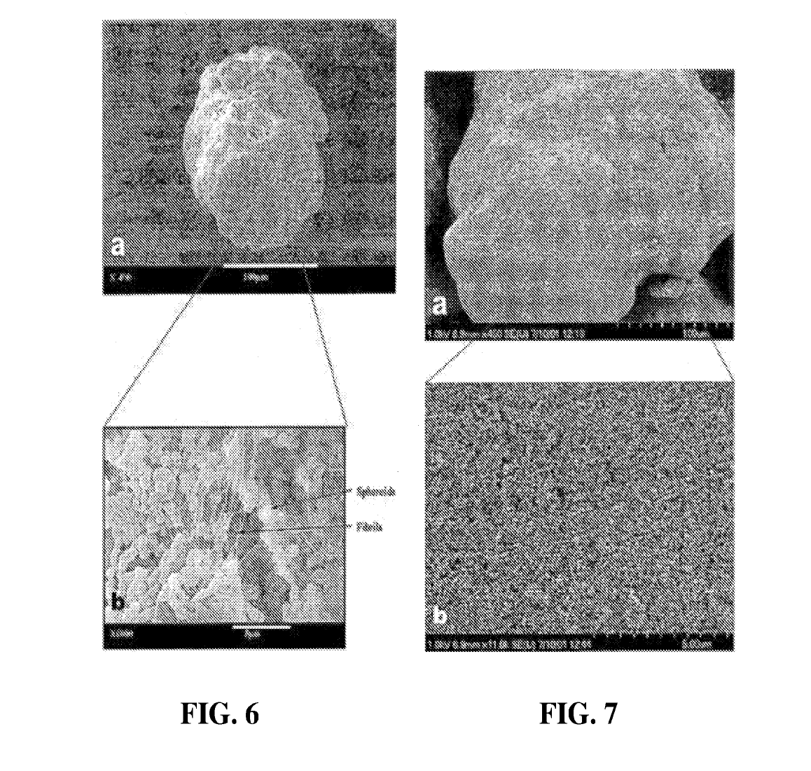

In forming the composite material according to this aspect, a granular polymer, such as, for example and not meant to be limiting, the UHMWPE illustrated in FIG. 6, can be dry mixed with a conductive filler that is also in particulate form. FIG. 6A is an FESEM image of a single UHMWPE granule. The granule shown in FIG. 6A has a diameter of approximately 150 μm, though readily available UHMWPE in general can have a granule diameter in a range of from about 50 μm to about 200 μm. FIG. 6B is an enlarged FESEM image of the boxed area shown on FIG. 6A. As can be seen, the individual granule is made up of multiple sub-micron sized spheroids and nano-sized fibrils surrounded by varying amounts of free space.

In one exemplary aspect, carbon nano-tubes or carbon nano-fibers can be used as the conductive filler to be mixed with the polymer. In another aspect, carbon black conductive filler can be mixed with the polymer. Carbon black is readily available in a wide variety of agglomerate sizes, generally ranging in diameter from about 1 μm to about 100 μm that can be broken down into smaller aggregates of from about 10 nm to about 500 nm upon application of suitable energy. For example, FIG. 5A is an FESEM image of a carbon black powder agglomerate having a diameter of approximately 10 μm. In FIG. 5B, individual carbon black aggregates forming the agglomerate can clearly be distinguished. The circled section of FIG. 5B shows a single carbon black aggregate loosely attached to the larger agglomerate. As the scale of FIG. 5B illustrates, the aggregates in this particular image range in size from about 50 nm to about 500 nm. In the circled section of FIG. 5B can be seen the smaller, spherical primary particles of carbon black, the size of which are often utilized when classifying commercial carbon black preparations. These primary particles make up the aggregate.

Upon dry mixing the particulate conductive filler with the larger particulate polymer material with suitable energy, the smaller granules of conductive filler material can completely coat the larger polymer granules. For instance, FIGS. 7A and 7B show FESEM micrographs of a single powder particle obtained following mixing of 8 wt % carbon black with 92 wt % UHMWPE. As can be seen, the UHMWPE particle is completely coated with carbon black aggregates. While not wishing to be bound by any particular theory, it is believed that forces of mixing combined with electrostatic attractive forces between the non-conductive polymeric particles and the smaller conductive particles are primarily responsible for breaking the agglomerates of the conductive material down into smaller aggregates and forming and holding the coating layer of the conductive material on the polymer particles during formation of the composite powder as well as during later conversion of the powdered composite material into a solid form.

Following formation of the mixture including a conductive filler and a polymeric material, the mixture can be converted as desired to form a solid composite material that is electrically conductive. The solid composite thus formed can also maintain the physical characteristics of the polymer in those aspects including a relatively low filler level in the composite. For example, in the aspect described above, in which the composite material includes a conductive filler mixed with UHMWPE, the powder can be converted via a compression molding process or a RAM extrusion process, as is generally known in the art, optionally followed by machining of the solid molded material, for instance in those aspects wherein a contact sensor describing a complex contact surface curvature is desired.

In other aspects however, and primarily depending upon the nature of the polymeric portion of the composite, other conversion methods may preferably be employed. For example and without limitation, in other aspects the polymeric portion of the composite material can optionally be a polymer, a co-polymer, or a mixture of polymers that can be suitable for other converting processes, and the composite polymeric material can be converted via, for instance, a relatively simple extrusion or injection molding process.

It is contemplated that the composite material of the disclosed sensors can optionally include other materials, in addition to the primary polymeric component and the conductive filler discussed above. Other fillers that can optionally be included in the disclosed composite materials of the present invention can include, for example, various ceramic fillers, aluminum oxide, zirconia, calcium, silicon, fibrous fillers, including carbon fibers and/or glass fibers, or any other fillers as are generally known in the art. In one aspect, the composite material can include an organic filler, such as may be added to improve sliding properties of the composite material. Such fillers include, for instance, tetrafluoroethylene or a fluororesin.

Optionally, a load cell and conditioning module as disclosed herein can be electrically connected in series with one or more conventional load sensors to form a hybrid load cell. In one aspect, the hybrid load cell can comprise a load cell and conditioning module as disclosed herein connected in series with a conventional strain gauge sensor. It is contemplated that the load cell as described herein and the strain gauge sensors can have equivalent full scale calibration values. In this aspect, the hybrid load cell can further comprise conventional strain gauge conditioning electronics configured to measure an output of the strain gauge. In another aspect, the microcontroller of the conditioning module can be in electrical communication with the strain gauge conditioning electronics. In a further aspect, the microcontroller can be configured to communicate a hybrid load cell output to a LED readout or other conventional display means. In this aspect, the microcontroller can be configured to receive the load cell output as described herein during periods when the load applied to the hybrid load cell is less than a predetermined percentage of full scale. The microcontroller can be further configured to receive an output from the strain gauge during periods when the load applied to the hybrid load cell is greater than or equal to the predetermined percentage of full scale. For example, and without limitation, the predetermined percentage of full scale can be between about 5% and 15% of full scale. Thus, it is contemplated that the hybrid load cell output can be equal to the load cell output as described herein until the load applied to the hybrid load cell reaches the predetermined percentage of full scale.

Alternatively, the hybrid load cell can comprise means for attenuating the load cell output as described herein to be less than the output of the strain gauge. It is contemplated that the microcontroller can be configured to receive the load cell output as described herein until the output increases to a predetermined voltage. After the output is greater than or equal to the predetermined voltage, then the microcontroller can be configured to receive the output from the spring gauge.

It is contemplated that the hybrid load cell as described herein can maximize the accuracy of load measurements across a wide range of applied loads. In particular, it is contemplated that the accuracy of the hybrid load cell can be substantial consistent from approximately 0% to approximately 90% of full scale. It is further contemplated that the hybrid load cell as described herein can ensure that the zero balance is minimized. In one aspect, the hybrid load cell described herein can have a repeatability of less than about 0.10% at 0.10% of full scale and less than about 0.20% at 0.50% full scale. More preferably, the repeatability of the hybrid load cell can be less than about 0.05% at 0.10% of full scale and less than about 0.10% at 0.50% of full scale. In an additional aspect, the hybrid load cell described herein can have hysteresis of less than 0.01% at 0.10% of full scale and less than about 0.02% at 0.50% of full scale. More preferably, the hysteresis of the hybrid load cell can be less than about 0.002% at 0.10% of full scale and less than about 0.01% at 0.5% of full scale.

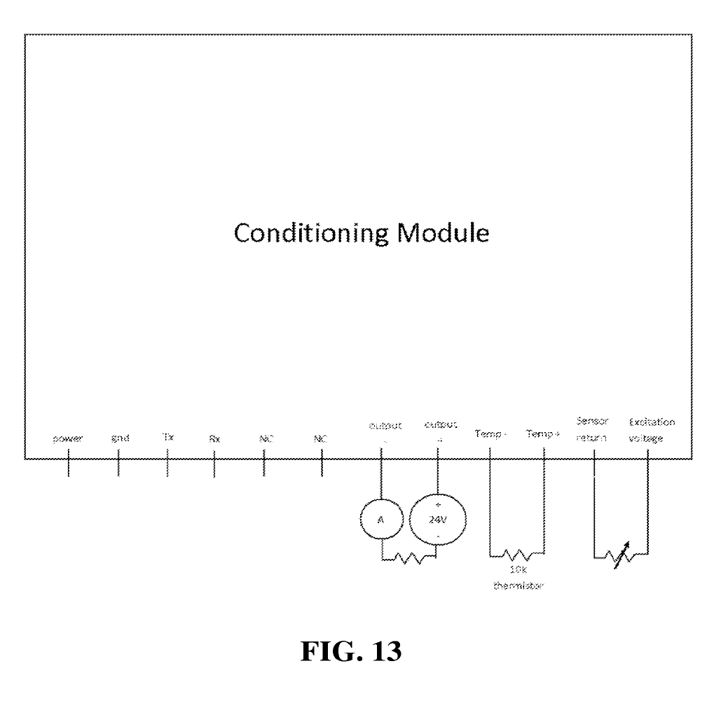

FIG. 13 is a block diagram illustrating an exemplary operating environment for performing the disclosed methods and portions thereof. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, hand-held electronic devices, vehicle-embedded electronic devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. In one aspect, the program modules can comprise a system control module. The disclosed method can also be practiced in grid-based and distributed computing environments where tasks are performed by remote processing devices that are linked through a communications network. In a distributed computing environment, program modules can be located in both local and remote computer storage media including memory storage devices.

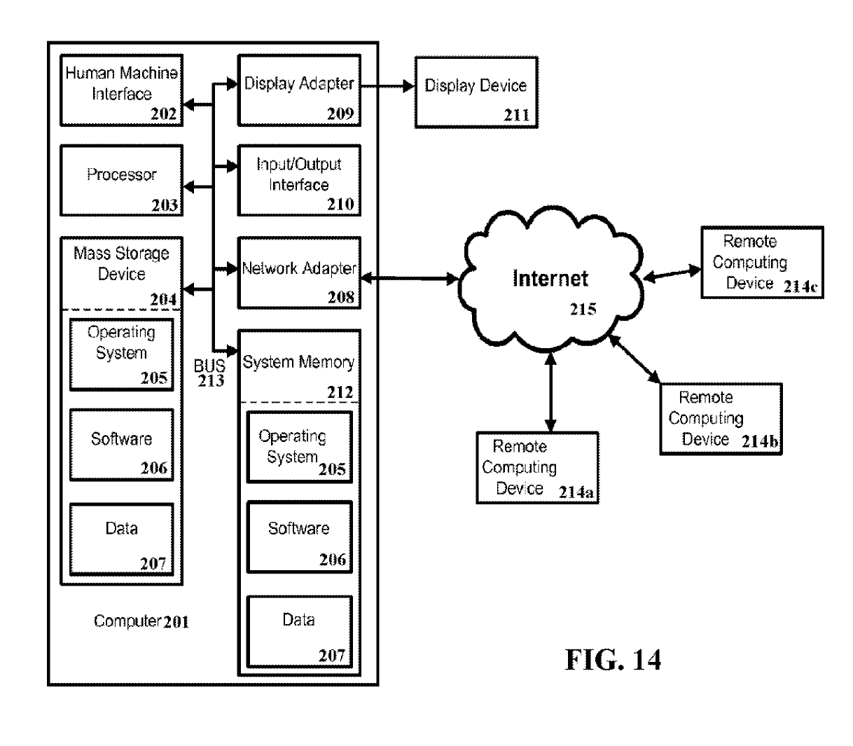

Further, one skilled in the art will appreciate that the system and method disclosed herein can be implemented via a general-purpose computing device in the form of a computer 200. As schematically illustrated in FIG. 14, the components of the computer 200 can comprise, but are not limited to, one or more processors or processing units 203, a system memory 212, and a system bus 213 that couples various system components including the processor 203 to the system memory 212.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 213, and all buses specified in this description can also be implemented over a wired or wireless network connection and each of the subsystems, including the processor 203, a mass storage device 204, an operating system 205, load cell software 206, load cell and/or treatment data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system.

The computer 200 typically comprises a variety of computer readable media. Exemplary readable media can be any available media that is accessible by the computer 200 and comprises, for example and not meant to be limiting, both volatile and non-volatile media, removable and non-removable media. The system memory 212 can comprise computer readable media in the form of volatile memory, such as random access memory (RAM), and/or non-volatile memory, such as read only memory (ROM). The system memory 212 typically contains data such as pressure and/or hysteresis data 207 and/or program modules such as operating system 205 and load cell module software 206 that are immediately accessible to and/or are presently operated on by the processing unit 203.

In another aspect, the computer 200 can also comprise other removable/non-removable, volatile/non-volatile computer storage media. By way of example, FIG. 14 illustrates a mass storage device 204 which can provide non-volatile storage of computer code, computer readable instructions, data structures, program modules, and other data for the computer 200. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and load cell module software 206. Each of the operating system 205 and load cell module software 206 (or some combination thereof) can comprise elements of the programming and the load cell module software 206. Pressure and/or hysteresis data 207 can also be stored on the mass storage device 204. Pressure and/or hysteresis data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 200 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computer 200 can have more than one display adapter 209 and the computer 200 can have more than one display device 211. For example, a display device can be a monitor, an LCD (Liquid Crystal Display), or a projector. In addition to the display device 211, other output peripheral devices can comprise components such as a printer (not shown) which can be connected to the computer 200 via Input/Output Interface 210.

The computer 200 can operate in a networked environment using logical connections to one or more remote computing devices 214a,b,c. By way of example, a remote computing device can be a personal computer, portable computer, a server, a router, a network computer, a peer device or other common network node, and so on. Logical connections between the computer 200 and a remote computing device 214a,b,c can be made via a local area network (LAN) and a general wide area network (WAN). Such network connections can be through a network adapter 208. A network adapter 208 can be implemented in both wired and wireless environments. Such networking environments are conventional and commonplace in offices, enterprise-wide computer networks, intranets, and the Internet 215.

For purposes of illustration, application programs and other executable program components such as the operating system 205 are illustrated herein as discrete blocks, although it is recognized that such programs and components reside at various times in different storage components of the computing device 200, and are executed by the data processor(s) of the computer. An implementation of load cell software 206 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

In various aspects, it is contemplated that the methods and systems described herein can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

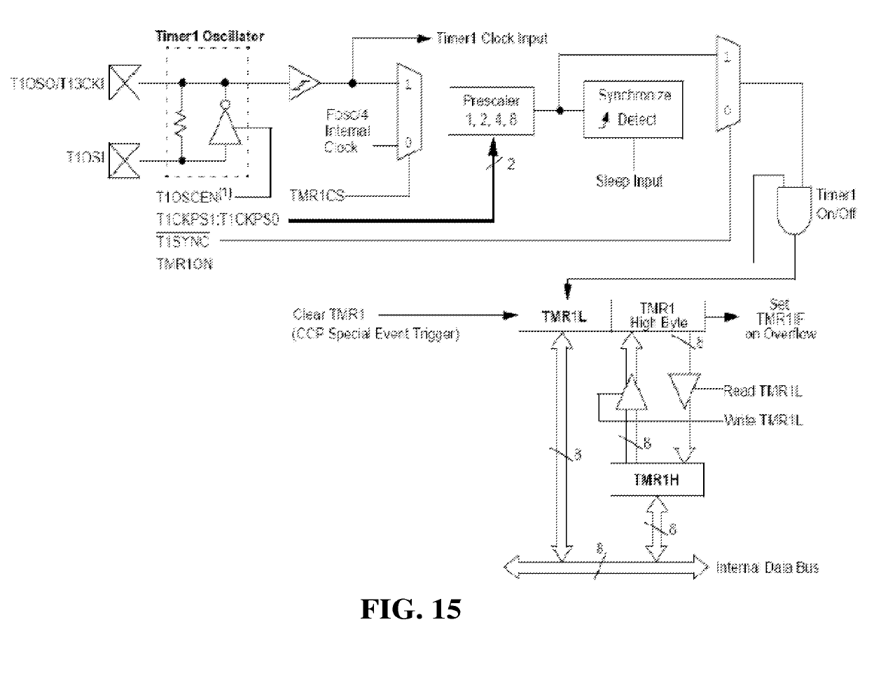

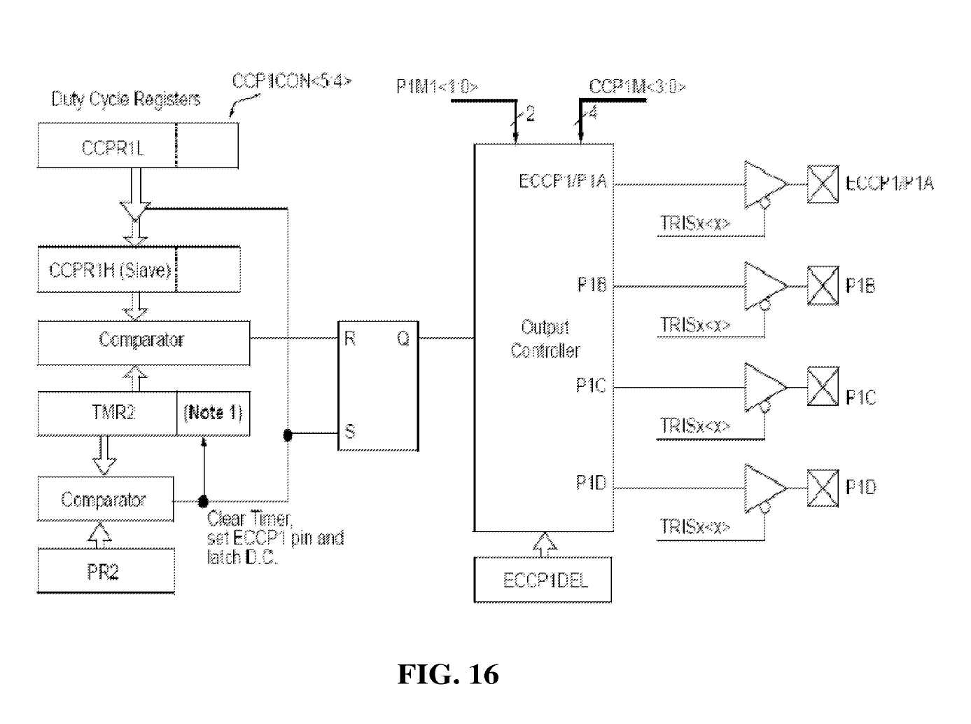

In one aspect, and referring to FIGS. 15-16, the conversion of the load cell output can be timed by the controller. In this aspect, it is contemplated that a hardware, or optionally software timer, can be loaded with a “rollover” value, such that, when it has counted a desired time interval, the timer will start the A/D converter and resets itself to zero to repeat the process. In one exemplary aspect, it is contemplated that a new conversion starts every 125 millisecond for an overall 8 KHz sampling rate.

In one example, and referring to FIG. 15, the TIMER1 of the conditioning module can be wire to the second “Enhanced Capture, Control and PWM” module (the “ECCP2”). Referring to a PIC19F8722 Family Datasheet, an A/D conversion can be started by the special event trigger of the ECCP2 module. When the trigger occurs, the GO/DONE bit will be set, starting the A/D acquisition and conversion and the Timer 1 (or Timer3) counter will be reset to zero. Timer 1 (or Timer3) is reset to automatically repeat the A/D acquisition period with minimal software overhead. In one aspect, the prescaler is loaded as appropriate and the CP Special Event Trigger is set to trip at a 125 millisecond interval. Simultaneously with the start of the A/D conversion, the timer is reset. The D/A output is latched to the same timer.

Referring now to FIG. 16, showing a block diagram of the ECCP1 system, which, like the ECCP2 (which trips the A/D conversion) is also locked to TIMER1. Here, shortly after TIMER1 rollover, the value in the “comparator” is equal to what is in TIMER1. Thus, with the proper value loaded in the comparator, the ECCP1/P1A pin will toggle at an interval precisely behind the actual taking of the A/D conversion reading.

In another aspect, it is contemplated that an A/D reading for pressure is taken and an A/D reading for temperature is taken. The pressure A/D value can then be run through a lowpass filter algorithm to remove noise and set an upper frequency limit on response. That pressure result can be then run through a set of pressure lookup tables. The temperature A/D value can be run though a set of temperature lookup tables to provide a temperature correction factor. After the temperature correction factor is calculated, a subtraction of any value for “zero calibration” is accomplished to insure that “zero” is the actual “zero” point of the load cell. This “zero cal” value can be stored in the EEPROM of the device and its value can be retained though a power cycle of the device. It is contemplated that this “zero cal” value is not retained though a reprogramming activity.

These and other modifications and variations to the present invention may be practiced by those of ordinary skill in the art, without departing from the spirit and scope of the present invention, which is more particularly set forth in the appended claims. In addition, it should be understood that aspects of the various aspects may be interchanged either in whole or in part. Furthermore, those of ordinary skill in the art will appreciate that the foregoing description is by way of example only, and is not intended to limit the invention so further described in such appended claims.

We claim:

1. A load cell, comprising:
a load cell housing defining an interior cavity and a bore in a first exterior face of the load cell housing that is in communication with the interior cavity;
a load knob configured for substantially axial movement along an axis of the bore of the cell housing, a proximal end of the load knob protruding above the first exterior face of the load housing and a distal end of the knob being positioned therein the interior cavity of the load cell housing;
a first electrode positioned in the interior cavity of the load cell underlying the distal end of the load knob;
a second electrode positioned in the interior cavity of the load cell and underlying the first electrode;
a conductive polymer element positioned in the interior cavity of the load cell between the respective first and second electrodes;
a conditioning module in communication with the first and second electrodes; and
a means for measuring the current flow in the electrical circuit to determine the relative compressive or tensile forces being applied on to the load knob,
wherein the first and second electrodes and the conductive polymer element complete an electrical circuit.

2. The load cell of claim 1, wherein the means for measuring the current flow in the electrical circuit generates a load cell output.

3. The load cell of any of the above claims, wherein the load cell output is between about 4 mA to about 20 mA.

4. The load cell of any of the above claims, wherein the conditioning module further comprises a power source.

5. The load cell of any of the above claims, wherein the conditioning module comprises a controller configured to perform the step of converting the load cell output into a substantially linear output.

6. The load cell of any of the above claims, wherein the conditioning module further comprises a shunt resistor in electrical communication with the electrical circuit.

7. The load cell of any of the above claims, wherein the shunt resistor has a resistance between about 2 Ohms to about 10,000 Ohms.

8. The load cell of any of the above claims, wherein the shunt resistor has a resistance between about 10 Ohms to about 1,000 Ohms.

9. The load cell of any of the above claims, wherein the conditioning module further comprises an analog/digital converter configured to measure the voltage drop across the shunt resistor.

10. The load cell of any of the above claims, wherein the controller is configured to digitally filter the output of the analog/digital converter.

11. The load cell of any of the above claims, wherein the controller is configured to perform the steps of controlling the voltage supplied from the power source to the electrical circuit.

12. The load cell of any of the above claims, wherein a response time of the load cell is from about 1 microsecond to about 10 microseconds.

13. The load cell of any of the above claims, wherein at least a portion of the exterior surface of the proximal end of the load knob can comprise an arcuate surface.

14. The load cell of any of the above claims, wherein the load knob further comprises a load member that is configured to form the distal end of the load knob.

15. The load cell of any of the above claims, further comprising an insulator positioned between the load member and the first electrode.

16. The load cell of any of the above claims, wherein the conductive polymer element comprises a substantially inflexible conductive pressure sensitive composite material that comprises an electrically conducive filler and a polymeric material.

17. The load cell of any of the above claims, wherein the polymeric material comprises polyphenylene sulfide.

18. The load cell of any of the above claims, wherein a desired amount of conductive filler can range from about 0.2% to about 20% by weight of the pressure sensitive composite material.

19. The load cell of any of the above claims, wherein a desired amount of conductive filler can range from about 0.5% to about 10% by weight of the pressure sensitive composite material.

20. The load cell of any of the above claims, wherein a desired amount of conductive filler can range from about 1% to about 3% by weight of the pressure sensitive composite material.

21. The load cell of any of the above claims, wherein the conductive filler comprises carbon black.

22. The load cell of any of the above claims, wherein the pressure sensitive composite material further comprises ceramic fillers, aluminum oxide, zirconia, calcium, silicon, fibrous fillers, carbon fibers, glass fibers, and/or organic fillers.

23. The load cell of any of the above claims, further comprising at least one strain gauge that is electrically connected in series with the load cell.

24. The load cell of any of the above claims, further comprising means for attenuating the load cell output as described herein to be less than the output of the strain gauge.

25. The load cell of any of the above claims, wherein the controller is configured to perform the steps of: receiving the load cell output from the load cell until the output increases to a predetermined voltage, or receiving the output from the strain gauge when the output is greater than or equal to the predetermined voltage.
